(19) United States
(12) Patent Application Publication
(10) Pub. No.: US 2003/0088694 A1
(43) Pub. Date: May 8, 2003

(54) Multicasting method and switch

(75) Inventors: Darrin M. Patek, Thousand Oaks, CA (US); Shaun Clem, Thousand Oaks, CA (US); Todd L. Khacherian, Moorpark, CA (US); Jimmy Pu, Agoura Hills, CA (US); Chris Reed, Oxnard, CA (US)

Correspondence Address: COUDERT BROTHERS, Third Floor, 600 Beach Street, San Francisco, CA, 94109, US

(73) Assignee: Internet Machines Corporation

(21) Appl. No.: 10/033,328

(22) Filed: Nov. 2, 2001

(51) Int. Cl. G06F 15/173

(52) U.S. Cl. 709/238

(57) ABSTRACT

A method and system is provided for the scheduling of multicast frames in a switching network. In one exemplary embodiment, a destination identifier in an incoming frame to be multicast is used to determine an output port mask via a table lookup. The output port mask is used to determine which selected output ports receive a copy of the incoming frame. The selected output ports are copied to concurrently. Thus an efficient and simple method and system is provided to multicast an incoming frame.

### FIELD OF THE INVENTION

The present invention relates generally to multi-casting in a switching network, and in particular to techniques for performing multi-casting in a router or switch.

### BACKGROUND OF THE INVENTION

Today the use of the Internet is increasing explosively. With this widespread use has been increasing demand for larger transmission bandwidth. Such demands have evolved from megabits to gigabits per second, as applications such as multimedia become prevalent. While optical fibers improve the bandwidth of the transmission lines, the switches which route the traffic are a bottleneck. Much research and development is being done in the area of high speed switches, especially to handle the rapidly rising gigabits per second (Gbps) traffic.

Several applications such as video and audio teleconferencing, video entertainment, distributed data processing, and advertising require the delivery of the same information to several locations, i.e., multicasting. An example development to meet the needs of sending streaming audio and video to multiple users at the same time is MBone or Multicast Internet, which uses a portion of the Internet for Internet Protocol (IP) multicasting.

Conventionally there are two types of multicasting service disciplines: 1) full multicast or one-shot in which all copies of a packet must be sent in the same time slot. If a packet does not get access to all of the outputs it needs due to contention, then the packet is not copied to any output port and it must try again in the next time slot; and 2) partial multicast or fanout-splitting in which copies are delivered to needed output ports over any number of time slots. Only copies that are unsuccessful in one time slot contend for the output ports in the next time slot. There are several problems with these approaches. First, there is typically the simplifying assumption that the packets are fixed sized. Analysis for variable sized packets is difficult. Next contention by copies of multicast packets at different input ports for the same output port reduces efficiency. In the full multicast case, an output port may be idle even with a copy destined for it. This may occur when another copy of the same multicast packet has a contention at another output port. In the case of the partial multicast, besides the overhead of detecting and managing contention, the multiple time slots needed to multicast a packet have a more complicated scheduling algorithm. In addition several multicasting approaches create duplicate copies of the multicast packet and hence increases the traffic.

Therefore, in the high data rate network environment where multicast traffic is becoming a significant proportion of the total traffic, techniques are needed which provide for simple, but efficient routing of multicast traffic.

### SUMMARY OF THE INVENTION

The present invention provides a method and system for the scheduling of multicast packets or frames in a switching network. In one exemplary embodiment, a destination identifier in an incoming frame to be multicast is used to determine an output port mask via a table lookup. The output port mask is used to determine which selected output ports receive a copy of the incoming frame. The selected output ports are copied to concurrently. Thus an efficient and simple method and system is provided to multicast an incoming frame.

In one embodiment of the present invention a method for sending a data item from a source to selected destinations of a plurality of destinations in a switching network is provided. First, the data item is examined to determine a routing identifier for the data item. Then using the routing identifier as an index, a data structure is accessed. The data structure includes routing control values for the plurality of destinations. Lastly, and the data item is concurrently transferred from the source to the selected destinations based on the routing control values.

Another embodiment of the present invention provides a method for multicasting a frame in a router, where the router includes an input queue and a plurality of output queues. The method includes, determining a destination identifier for the frame received by the input queue. Next, using the destination identifier, a data structure is determined and stored in a memory. The data structure includes a mask for the plurality of output queues. And lastly, a reference to the frame is concurrently transferred to at least two selected output queue controllers in accordance with the mask.

Yet another embodiment of the present invention provides a multicasting system in a switching fabric for routing data in a frame received at an input queue to a plurality of selected output queues. The multicasting system includes, a table having a plurality of predetermined routes, wherein the table is addressed by a destination ID in the frame and includes a mask corresponding to the destination ID; a memory for storing the mask, wherein the mask indicates the plurality of selected output queues; and selected output queue control modules for the plurality of selected output queues, wherein the selected output queue control modules are used for copying the data to the plurality of selected output queues.

A further embodiment of the present invention provides a system for multicasting a frame in a router having a plurality of input ports and a plurality of output ports. The system includes: a first crossbar switch for transferring the frame from an input port of the plurality of input ports to a shared memory; a frame pointer for referencing the frame stored in the shared memory; a second crossbar switch for transferring the frame using the frame pointer to a plurality of selected output ports of the plurality of output ports; and a control unit for selecting the plurality of selected output ports using a multicast data structure having predetermined multicast routes.

These and other features, aspects and advantages of the present invention will become better understood with regard to the following description, appended claims and accompanying drawings

### BRIEF DESCRIPTION OF THE DRAWINGS

FIG. 1 shows a schematic circuit diagram of a router (or switch) of an embodiment of the present invention;

FIG. 2 is a simplified expanded view of an embodiment of the switching fabric of FIG. 1 of the present invention;

FIG. 3 shows examples of the unicast frame format and the multicast frame format of one embodiment of the present invention;

FIG. 4 shows examples of the unicast frame format and the multicast frame format of another embodiment of the present invention;

FIG. 5 is a simplified block diagram illustrating the multicasting routing process for an embodiment of the present invention; and

FIG. 6 is a flowchart illustrating a method for multicasting of an embodiment of the present invention.

### DETAILED DESCRIPTION OF THE INVENTION

In the following description, numerous specific details are set forth to provide a more thorough description of the specific embodiments of the invention. It is apparent, however, to one skilled in the art, that the invention may be practiced without all the specific details given below. In other instances, well known features have not been described in detail so as not to obscure the invention.

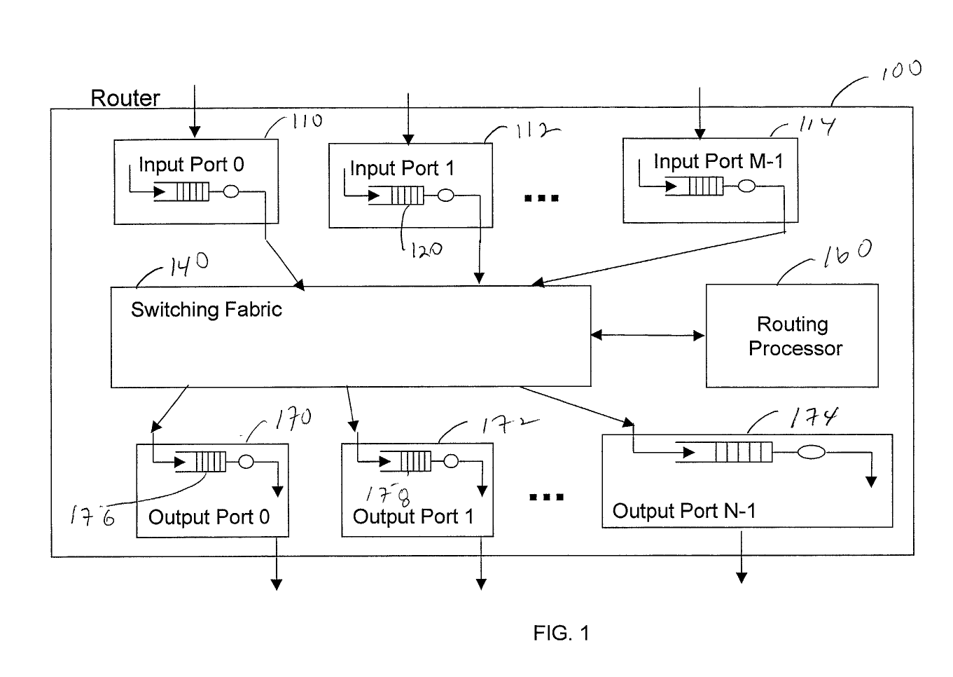

FIG. 1 shows a schematic circuit diagram of a router (or switch) of an embodiment of the present invention. The router 100 takes frames or packets received through its M input ports, e.g., input port 0 110, input port 1 112, to input port M-1 114 and routes them via switching fabric 140 to the appropriate N-1 output ports, e.g., output port 0 170, output port 1 172 through output port N-1 174 according to commands received from a routing processor 160. The switching fabric 140 in the router (or switch) 100 is a switching network. Each input port has one or more queues. For example, input port 1 112 has an input queue 120. While FIG. 1 shows only one queue for input port 1 112, the number of queues shown at input port 1 112 is for illustration purposes only and there may be one or more queues per each input port. In one embodiment the output ports have one output queue per port. In another embodiment there is zero, one, or more output queues per output port. For example, in output port 0 170, there is a output queue 176 and in output port 1 172, there is a output queue 178. In one embodiment M=N, and more specifically M=N=64.

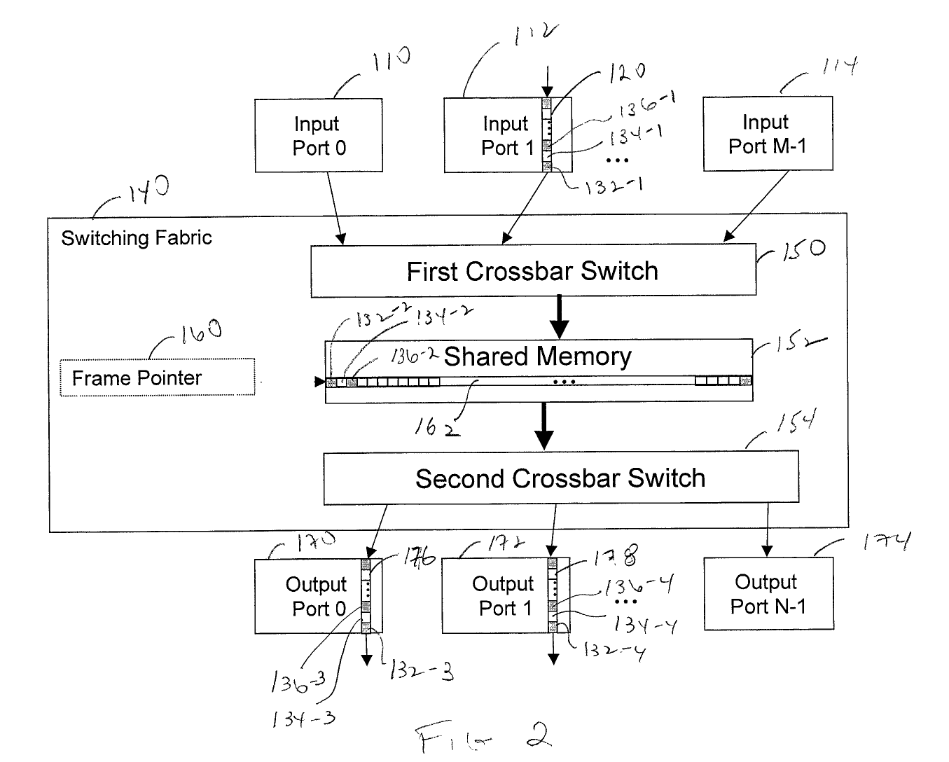

FIG. 2 is a simplified expanded view of the switching fabric 140 of FIG. 1 of an embodiment of the present invention. In this embodiment the switching fabric 140 includes a first crossbar switch 150, a shared memory 152, and a second crossbar switch 154. The first crossbar switch 150 is connected to the shared memory 152, and the shared memory 152 is then connected to the second crossbar switch 154. For illustration purposes only, input port 1 112 includes a First-in-First-out (FIFO) input queue 120. The input queue 120 is partitioned into a plurality of words (two bytes) for example words 132-1, 134-1, and 136-1. In another embodiment the input queue 120 is partitioned into a plurality of bytes. A frame enters the input queue and is partitioned into words. These words are then routed via the first crossbar switch 150 to a memory slice in shared memory 152. An example memory slice length is 64 words. For example, words 132-1, 134-1, and 136-1 in input queue 120 are routed via first crossbar switch 150 to memory slice 162 of shared memory 152. The first word in memory slice 162 is word 132-2 which corresponds to word 132-1 of input queue 120. Similarly, words 134-1 and 136-1 correspond to words 134-2 and 136-2 of memory slice 162, respectively. A frame pointer 160 points to or references the memory slice 162 of shared memory 152. In one embodiment the frame pointer 160 is a start of frame (SOF) pointer that addresses the starting location of the first word (or byte) of the memory slice. For illustration purposes, the frame length is assumed to be less than or equal to a memory slice length. However, the present invention is not so limited, the frame may cover two or more memory slices. In the case of one or more memory slices per frame, a separate link list is kept which links each memory slice with its next memory slice. The frame pointer 160 points to the memory slice, e.g., 162, as well as to an entry in the linked list. The entry in the linked list is either a byte count, indicating this is the last memory slice, or a pointer to the next memory slice making up the frame. Further details can be found in co-pending U.S. Utility patent application Ser. No. ______, titled “Variable Length Switch Fabric,” by Todd Khacherian et. al., filed Oct. 3, 2001 (Attorney Docket number 06979-0017), which is herein incorporated by reference in its entirety for all purposes.

As illustrated as an example in FIG. 2, data in input queue 120 of input port 1 is multicast to output queue 176 of output port 0 170 and output queue 178 of output port 1 172. First the frame in input queue 120 is copied to memory slice 162. Then the memory slice 162 pointed to by frame pointer 160 is copied to the two output queues 176 and 178. That is, for example, memory slice word 132-2 is copied to the two words, 132-3 of output queue 176 and 132-4 of output queue 178. Similarly, words 134-2 and 136-2 are copied to the two words 134-3 and 136-3 for output queue 176, respectively, and words 134-4 and 136-4 for output queue 178, respectively.

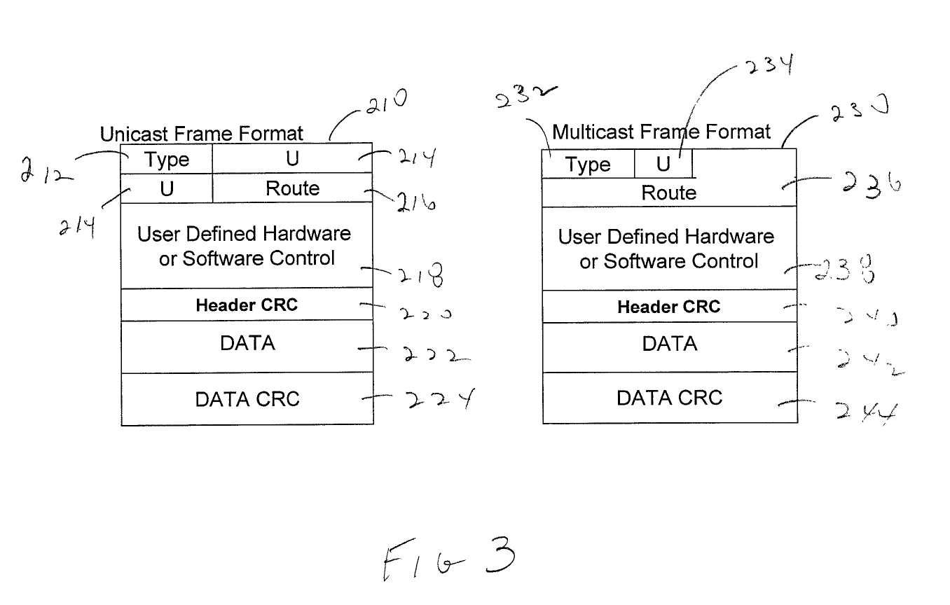

FIG. 3 shows examples of the unicast frame format and the multicast frame format of one embodiment of the present invention. The unicast frame format 210 includes a type field 212, e.g., 'b00, a route field 216, e.g., a 6-bit destination port ID, a user field 218, e.g., a five byte user defined hardware or software control field, a header Cyclic Redundancy Code (CRC) 220, e.g., CRC-8, 1 to 64 kbytes of data 222, and a data CRC 224, e.g., CRC-32. Note “U” 214 (and 234) means unused. The multicast frame format 230 includes a type field 232, e.g., 'b01, a route field 236, e.g., a 12-bit multicast flow ID, a user field 238, e.g., a five byte user defined hardware or software control field, a header Cyclic Redundancy Code (CRC) 240, e.g., CRC-8, 1 to 64 kbytes of data 242, and a data CRC 244, e.g., CRC-32.

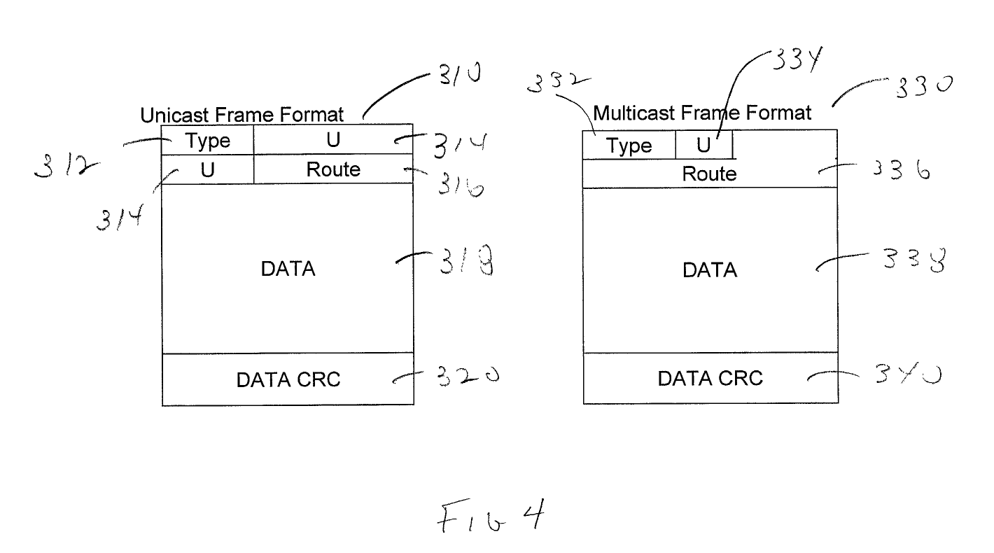

FIG. 4 shows examples of the unicast frame format and the multicast frame format of another embodiment of the present invention. The unicast frame format 310 includes a type field 312, e.g., 'b00, a route field 316, e.g., a 6-bit destination port ID, 1 to 64 kbytes of data 318, and a data CRC 320, e.g., CRC-32. Note “U” 314 (and 334) means unused. The multicast frame format 330 includes a type field 332, e.g., 'b01, a route field 336, e.g., a 12-bit multicast flow ID, 1 to 64 kbytes of data 338, and a data CRC 340, e.g., CRC-32.

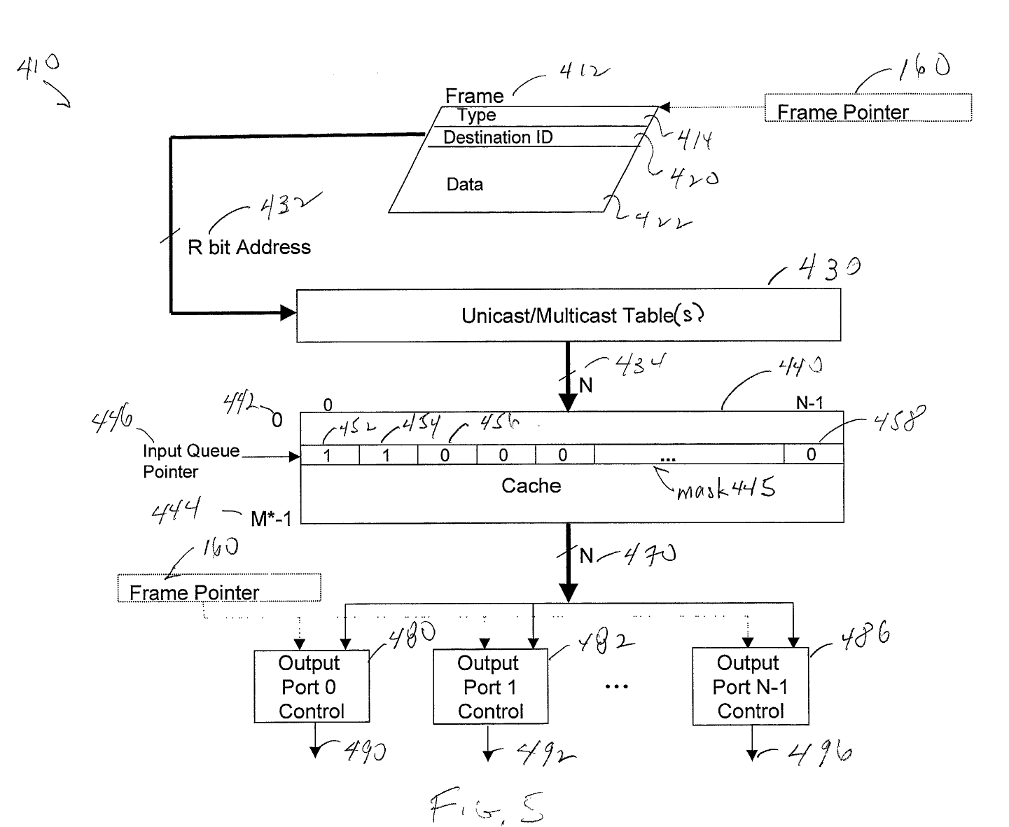

The architecture of FIG. 1 can be divided generally into a data flow as shown in FIG. 2 and a control flow as shown in FIG. 5. For example, in FIG. 2, the frame goes from the input queue 120 at input port 1 to memory slice 162 in shared memory 152 to output queues 176 and 178 in output ports 170 and 172. The control flow shown in FIG. 5 controls the routing of the words of the memory slice from the shared memory 152 to the output ports via the second crossbar switch 154.

FIG. 5 is a simplified block diagram illustrating the multicasting routing process for an embodiment of the present invention. FIG. 5 shows a Unicast/Mutlticast table(s) 430 coupled to a memory cache 440 via bus 434. The memory cache 440 is in turn coupled to a plurality of output port control modules, e.g., output port 0 control module 480, output port 1 control module 482, to output port N-1 control module 486, via bus 470. In an alternative embodiments the Unicast/Mutlticast table(s) 430 may be one table or may be one or more data structures in a database or a memory. The memory cache 440 may be a software or hardware cache, a random access memory (RAM), a flash memory, a hard drive, or any other volatile or non-volatile storage device. In one embodiment each selected output control module includes a head pointer queue, e.g., FIFO, having the frame pointer 160, where the output control module is selected using a mask, e.g., mask 445, stored in memory cache 440. The output of the selected output control modules is then used to control, directly or indirectly (via a linked list), the shared memory 152 and second crossbar switch 154 (FIG. 2) to copy one or more memory strips of shared memory 152 to the output queues, e.g., FIFOs, at the output ports. Further details of this embodiment are in co-pending U.S. Utility patent application Ser. No. ______, titled “Variable Length Switch Fabric,” by Todd Khacherian et. al., filed Oct. 3, 2001 (Attorney Docket number 06979-0017).

In another embodiment a frame 412 with an address given by frame pointer 160 includes a format having a type 414, a destination ID 420, and data 422. The frame 412 can have a unicast frame format 210 (FIG. 3), a multicast frame format 230 (FIG. 3), a unicast frame format 310 (FIG. 4), or a multicast frame format 330 (FIG. 4). The destination ID 420 shown in frame 412 corresponds to the route 216 or 236 of FIG. 3 or the route 316 or 336 of FIG. 4. The type 414 includes a code distinguishing a unicast, i.e., a frame routed to one output queue, from a multicast, i.e., a frame routed to two or more output queues. The data 422 is grouped in bytes or in words (two bytes per word). The destination ID 420 gives an R-bit address 432 or index into the Unicast/Mutlticast table 430. For example, R may be 11 bits representing about 2K indices into the Unicast/Mutlticast table(s) 430. In another embodiment R=12. In yet another embodiment R=16. Each index, e.g., R-bit address 432, points to a mask of N bits in length. In one embodiment N is the number of output queues, for example, N=64. In this embodiment there is one output queue per output port. In an alternative embodiments there is zero, one or more output queues per output port. Using a R-bit address 432, a N bit mask is looked up in Unicast/Multicast table(s) 430 and sent via bus 434 to cache 440. The N bit mask has one bit for each output port. In other embodiments the N bit mask has one or more bits for each output queue and may be greater than N bits in length. In yet other embodiments the N bit mask may have an encoded value, which when decoded specifies the appropriate output queue, and may be less than or equal to N bits in length.

The Unicast/Multicast table(s) 430 includes the routing data for both unicast and multicast frames. In one embodiment the Unicast/Multicast table(s) 430 is pre-loaded with pre-determined routes. In the multicast case, destination ID 420 of the frame 412 does not need to specify the destination addresses in the frame itself, as is required in the conventional case, and thus the size of the frame header is reduced. In addition, as the destination addresses are pre-calculated, only a table lookup is needed rather than performing the typical calculations to determine the route. Thus the present invention performs faster and/or has a smaller frame header size than the conventional multicast method and system.

The N-bit mask from the Unicast/Mutlticast table(s) 430 is then written to a row in cache memory 440, for example, mask 445 addressed by input queue pointer 446. The cache is N bits wide and has M* minus 1 (M*−1) rows, where M* is the number of input queues. In one embodiment there are N input queues for each output queue in order, among other things, to reduce Head-of-the-Line (HOL) blocking. Hence there are M times N input queues for M input queues and N output queues. For the purposes of illustration let N=M*=64, where each input port has one input queue. In this case the rows in cache 440 are addressed from 0 to 63, i.e., there are 64 masks. From the example of FIG. 2, the input queue pointer is the address for input port 1 112 and corresponds to mask 445. The entire cache 440 or each row individually in cache 440 can be locked, i.e., made non-modifiable. Locking all the rows in the cache 440, i.e., the entire cache 440, provides static routing. A unlocked or loadable row allows dynamic routing by allowing the frames or words to be re-routed to different output queues during the routing process.

In one embodiment of the present invention, a ‘1’ in the mask, e.g., bit 0 452, and bit 1 454 of mask 445 (FIG. 5), indicates that the words in a memory slice, e.g., 162 of FIG. 2, are to be loaded into the output ports associated with the mask bits, e.g., output port 0 170 and output port 1 172 (FIG. 2). A ‘0’ in the mask, e.g., bit N-1 458 of mask 445, indicates no data is to be copied to the N-1 output port 174. The mask, e.g., mask 445, controls the copying of segments from a memory slice (or slices) in shared memory 152, e.g., memory slice 162, by allowing frame pointer 160, which has, e.g., the start of frame (SOF) address for frame 412, to be written to the output port control modules, e.g., output port 0 control module 480 and output port 1 control module 482, only when the mask bit is ‘1,’ e.g., bits 452 and 454. The output control modules, e.g., output port 0 control module 480 and output port 1 control module 482, then send their control signals, e.g., 490 and 492, to the second cross bar switch 154, so that, for example, words 132-2, 134-2, and 136-2 of memory slice 162 (FIG. 2) having frame pointer 160, can be copied to queue 176 of output port 0 170 and queue 178 of output port 1 172. The mask, e.g., mask 445, stays in the cache 440 until the final portion of the frame is transferred from input queue 120 to the memory slice currently pointed to by the frame pointer 160 (FIG. 2).

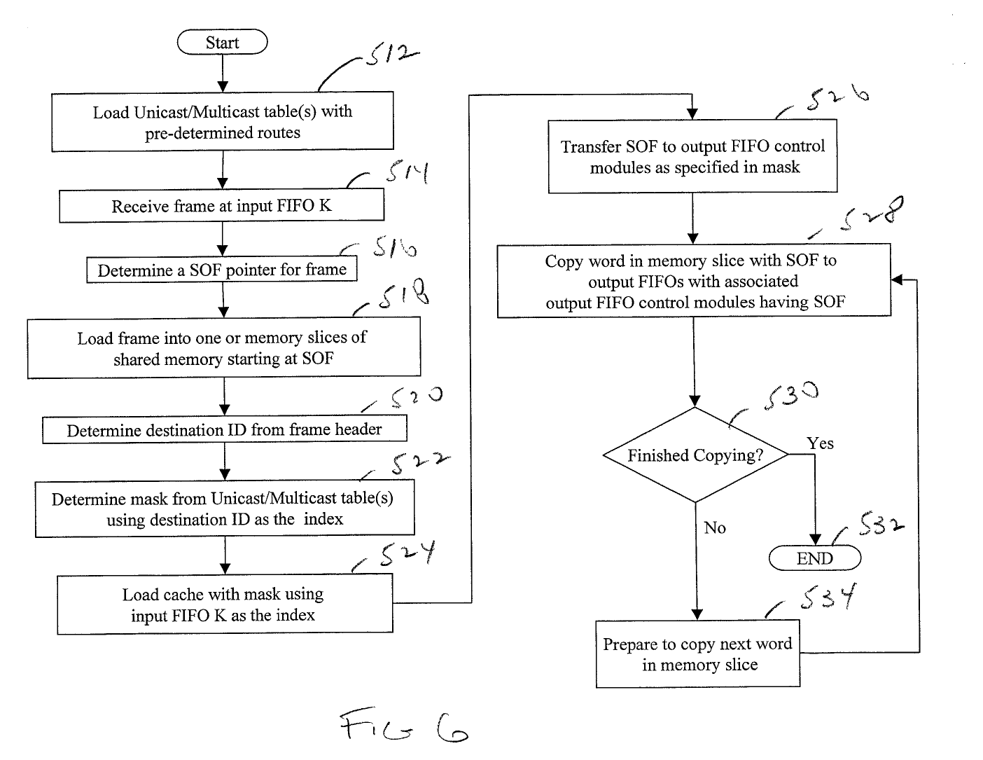

FIG. 6 is a flowchart illustrating another embodiment of the present invention. At step 512, Unicast/Multicast table(s) 430 is loaded with pre-determined routes. Next a frame 412 is received at input queue, i.e., FIFO queue, K (step 514). At step 516, a frame pointer 160, in this case a Start of Frame (SOF) pointer, is assigned to the frame 412. Each word of the frame 412 is then loaded into memory slice(s) of shared memory 152, starting at the address given by the SOF pointer (step 518). At step 520, the frame header in frame 412 is examined to determine the destination ID 420. At step 522, using the destination ID 420, i.e., K-bit address 432, as the index into the Unicast/Multicast table(s) 430, a mask, e.g., mask 162 (FIG. 2) or mask 445 (FIG. 5), is determined. This mask is loaded into a memory cache 440 at location given by input FIFO K (step 522), e.g., input queue pointer 446. At step 526, the mask is used to transfer to selected output control FIFOs, e.g., output port 0 control module 480 and output port 1 control module 482, the SOF pointer. At step 528, the selected output control FIFOs are read and a word starting at location SOF is copied to the output FIFO queues associated with the selected output control FIFOs, e.g., output queue 176 and output queue 178. At step 530, the memory slice(s) is checked to determine if the last word in the frame has been copied. If yes, then the routine ends. If no, then the next word in the frame is prepared to be copied (step 534) and the copying continues (goto step 528). In other embodiments the queues are not necessarily FIFOs, but the queues have other combinations of queues including FIFOs, priority queues, last in first out, or queues having other queuing routines known by one of ordinary skill in the arts.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the invention has been described using a particular series of transactions and steps, it should be apparent to those skilled in the art that the scope of the invention is not limited to the described series of transactions and steps.

Further, while the invention has been described using a particular combination of hardware and software, it should be recognized that other combinations of hardware and software also within the scope of the invention. The invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for sending a data item from a source to selected destinations of a plurality of destinations in a switching network, said method comprising:
examining said data item to determine a routing identifier for said data item;
using said routing identifier as an index, accessing a data structure comprising routing control values for said plurality of destinations; and
concurrently transferring said data item from said source to said selected destinations based on said routing control values.

2. The method of claim 1 wherein said data structure comprises a table.

3. The method of claim 2 wherein said table comprises predetermined routing information.

4. The method of claim 1 wherein said data item comprises a portion of a frame.

5. The method of claim 1 wherein said routing control values is part of a mask.

6. The method of claim 1 wherein said source comprises an input queue.

7. The method of claim 1 wherein said switching network is part of a router.

8. A method for multicasting a frame in a router, said router comprising an input queue and a plurality of output queues, said method comprising:
determining a destination identifier for said frame received by said input queue;
using said destination identifier, locating a data structure comprising a mask for said plurality of output queues; and
concurrently transferring a reference to said frame to at least two selected output queue controllers in accordance with said mask.

9. The method of claim 8 further comprising:
copying a word associated with said reference to said frame to selected out put queues of said plurality of output queues corresponding to said selected output queue controllers.

10. The method of claim 8 wherein said data structure comprises a table, said table comprising said mask.

11. The method of claim 10 wherein said destination identifier is an index into said table for selecting said mask.

12. The method of claim 8 wherein said frame is stored in a shared memory and is located by said reference to said frame.

13. The method of claim 8 wherein said reference to said frame includes a pointer to said frame.

14. A multicasting system in a switching fabric for routing data in a frame received at an input queue to a plurality of selected output queues, comprising:
a table having a plurality of predetermined routes, said table addressed by a destination ID in said frame, and said table comprising a mask corresponding to said destination ID;
a memory for storing said mask, said mask indicating said plurality of selected output queues; and
selected output queue control modules for said plurality of selected output queues, said selected output queue control modules used for copying said data to said plurality of selected output queues.

15. The multicasting system of claim 14 further comprising:
a start of frame pointer for addressing a memory area in a shared memory having said frame, wherein said start of frame pointer is concurrently copied to said selected output queue modules.

16. The multicasting system of claim 14 wherein said frame has a frame format comprising: a type, a destination ID, and data.

17. The multicasting system of claim 14 wherein said frame has a frame format comprising: a type, a route, and user defined control information.

18. The multicasting system of claim 14 wherein said frame has a frame format comprising: a type, a route, and data.

19. The multicasting system of claim 18 wherein said route includes a multicast flow ID.

20. The multicasting system of claim 18 wherein said route includes a unicast destination port ID.

21. The multicasting system of claim 18 wherein said memory for storing said mask includes a lockable row.

22. A system for multicasting a frame in a router having a plurality of input ports and a plurality of output ports, comprising:
a first crossbar switch for transferring said frame from an input port of said plurality of input ports to a shared memory;
a frame pointer for referencing said frame stored in said shared memory;
a second crossbar switch for transferring said frame using said frame pointer to a plurality of selected output ports of said plurality of output ports; and
a control unit for selecting said plurality of selected output ports using a multicast data structure having predetermined multicast routes.

23. The system of claim 22 wherein transferring said frame using said frame pointer to a plurality of selected output ports happens in parallel.

24. The system of claim 22 wherein said control unit comprises a lockable cache memory for storing a mask, said mask used in selecting said plurality of selected output ports.

25. A method for sending a frame from a source to selected destinations of a plurality of destinations in a router, said method comprising:
means for examining said frame to determine a destination identifier for said frame;
using said destination identifier as an index, means for accessing a data structure comprising a mask for said plurality of destinations; and
means for concurrently transferring at least one portion of said frame from said source to said selected destinations based on said mask.
